(19) United States
(12) Patent Application Publication
(10) Pub. No.: US 2026/0065299 A1
(43) Pub. Date: Mar. 5, 2026

(54) EXECUTING AUTOMATED SHOPPING TASKS

(71) Applicant: Stretch Collective Inc., New York, NY (US)

(72) Inventors: Carman Wenkoff, Nashville, TN (US); Adam Wenkoff, Santa Monica, CA (US)

(21) Appl. No.: 19/319,002

(22) Filed: Sep. 4, 2025

Related U.S. Application Data
(60) Provisional application No. 63/690,396, filed on Sep. 4, 2024.
(60) Provisional application No. 63/690,388, filed on Sep. 4, 2024.

(51) Int. Cl. G06Q 30/018; G06V 30/41; G06V 30/42

(52) U.S. Cl. CPC G06Q 30/0185; G06V 30/41; G06V 30/42

(57) ABSTRACT

Methods and systems, including computer-readable media, are described for verifying a purchase receipt. A computing system verifies a purchase receipt by implementing a method that includes extracting line-item purchase information data elements from an image of the purchase receipt. The method includes retrieving expected item pricing data and expected tax data from a retailer-specific database indexed by region and data for each item. The method includes identifying a data element having a difference between a unit price represented in the corresponding data element and an expected unit price represented in the corresponding expected item pricing data, in which the difference meets a configurable threshold and corresponds to a purchase price discrepancy. The method includes constructing a discrepancy report having a structured data format, transmitting the discrepancy report to a retailer system over a preferred communication channel determined by a retailer profile associated with the retailer.

### CROSS-REFERENCE TO RELATED APPLICATIONS

This application claims the benefit of priority under 35 U.S. C. § 119 to U.S. Provisional Ser. No. 63/690,388 , filed on Sep. 4, 2024, and to U.S. Provisional Ser. No. 63/690,396 , filed on Sep. 4, 2024. The entire contents of both applications are incorporated by reference herein.

### TECHNICAL BACKGROUND

This disclosure generally relates to executing automated shopping tasks.

### BACKGROUND

Online shopping platforms offer customers an opportunity to browse and purchase a wide range of products, from everyday necessities to specialty items. Many e-commerce websites and apps include software systems that offer product recommendations, displaying curated lists based on factors like browsing history, popular trends, or related product categories. These systems are designed to help users find items that might interest them, providing suggestions that enhance the overall shopping experience.

### SUMMARY

This disclosure describes techniques for recommending shopping items and sequences of shopping locations that offer the recommended shopping items for sale. This disclosure further describes techniques for verifying a purchase receipt.

The techniques and systems for recommending shopping items described in this specification include an analysis of multiple shopping items offered by multiple shopping locations in a region. The analysis includes recommended lists of shopping items based on historical shopping data and recommended shopping trips, e.g., sequences of shopping locations. The system presents the recommended shopping trips as multiple trip options, in which each option is optimized based on particular user-defined criteria, e.g., budget, distance, convenience, etc.

As users interact with a user interface, execute shopping trips, and provide feedback, the system can re-train and refine machine learning models that serve as a recommendation engine. The machine learning models process historical shopping data, user preferences for shopping items, user criteria for shopping trips, and real-time pricing and inventory data from individual retailers.

In a first example implementation of the present application, a method for verifying a purchase receipt from a retail includes extracting one or more line-item purchase information data elements from an image of the purchase receipt, each data element comprising an item name, a quantity, a unit price, and a tax, wherein the image of the purchase receipt is a scanned image of the purchase receipt, or a digital image of the purchase receipt generated by using optical character recognition (OCR). The method includes retrieving, for each data element, expected item pricing data and expected tax data from a retailer-specific database indexed by region and date. The method includes identifying a data element having a difference between a unit price represented in the corresponding data element and an expected unit price represented in the corresponding expected item pricing data, the difference meeting a configurable threshold, wherein the difference is a corresponding purchase price discrepancy. The method includes constructing a discrepancy report having a structured data format, wherein the discrepancy report comprises receipt metadata, itemized differences, and recommended claim language and transmitting the discrepancy report to a retailer system over a preferred communication channel determined by a retailer profile associated with the retailer.

In an aspect combinable with the first example implementation, the purchase receipt is received as a digital image, a PDF, or a scanned uploaded image via a mobile application, browser extension, or email ingestion pipeline.

In another aspect combinable with one, some, or all of the previous aspects, the method includes rendering the image of the purchase receipt and parsed purchase data in a side-by-side display format, wherein the parsed purchase data comprises the one or more line-item purchase information data elements, the rendered parsed purchase data having a highlighted purchase price discrepancy and a corresponding confidence score for each data element having a price discrepancy that meets the configurable threshold and receiving a user review input and a user confirmation input through an interactive user interface, the user review input comprising corrections and annotations in relation to the rendered parsed purchase data.

In another aspect combinable with one, some, or all of the previous aspects, the method includes storing, in a user-specific and retailer-indexed database, time-stamped data records comprising the image of the purchase receipt, the parsed purchase data, the expected item pricing data for each line-item purchase information data element, and a purchase price discrepancy for each line-item purchase information data element, wherein the storage of the time-stamped data records facilitates an analysis of claim history and claim analytics.

In another aspect combinable with one, some, or all of the previous aspects, the method includes converting the image of the purchase receipt to a structured digital data format using advanced OCR with contextual text grouping, store layout heuristics, and machine learning (ML)-based normalization of product names.

In another aspect combinable with one, some, or all of the previous aspects, the method includes generating a personalized alert to a user, wherein the personalized alert comprises a summary of the discrepancy report, the summary comprising an overpayment amount associated with the identified data element, matching policy references associated with the retailer, and a call-to-action for approval or automatic claim filing.

In another aspect combinable with one, some, or all of the previous aspects, the line-item purchase information data elements each comprise a line-item price, a tax, applied promotions, loyalty discounts, and store identifiers associated with a corresponding line-item.

In another aspect combinable with one, some, or all of the previous aspects, the communication channel comprises one or more of a prefilled retailer web form, a templated customer service email, a phone-based interactive voice response (IVR) script, a chatbot initiation, or a channel for scheduling a live customer support callback.

In a second example implementation of the present application, a method includes receiving a digital image or structured data representation of a purchase receipt via a user interface, extracting line-item data comprising item names, unit prices, and quantities using optical character recognition and natural language parsing, retrieving expected purchase data for each item based on retailer-specific and region-specific pricing feeds, computing price deviations for each item using a price comparison module, generating a discrepancy report comprising affected items, deviation values, and store metadata, and transmitting the report or a corresponding message to a predefined retailer resolution channel.

In an aspect combinable with the second example implementation, the method includes receiving a high-resolution image of a physical or digital receipt.

In another aspect combinable with one, some, or all of the previous aspects, the method includes rendering a user interface, wherein the user interface comprises (a) a visual overlay of parsed line-item data aligned with receipt coordinates, (b) color-coded annotations indicating price discrepancies, and (c) interactive options for item confirmation or correction.

In another aspect combinable with one, some, or all of the previous aspects, the method includes storing normalized purchase data, retrieved expected price entries, and computed discrepancy metrics in a time-stamped, user-linked audit log for subsequent reporting or analytics.

In another aspect combinable with one, some, or all of the previous aspects, the method includes converting image-based receipt content into structured JSON data containing line-item SKUs, descriptions, and price fields using machine-learning-enhanced optical character recognition (OCR).

In another aspect combinable with one, some, or all of the previous aspects, the method includes generating a mobile or email notification comprising a summary of detected discrepancies, a financial impact of the detected discrepancies, and an action button to initiate retailer contact or dispute submission.

In another aspect combinable with one, some, or all of the previous aspects, the purchase information comprises item-level metadata comprising unit price, quantity, extended price, discount applied, and store ID, extracted or inferred from receipt structure.

In another aspect combinable with one, some, or all of the previous aspects, the communication comprises an automated template pre-filled with discrepancy details, and is transmitted through retailer-specific APIs, secure web forms, or a call-center escalation system.

In a third example implementation of the present application, a method includes extracting receipt content, comparing item prices to external retail pricing feeds, identifying discrepancies, and transmitting formatted reports to retailer resolution endpoints.

In an aspect combinable with the third example implementation, the method includes capturing or receiving an image of a receipt, detecting layout regions via computer vision, and isolating line-item rows for extraction.

In another aspect combinable with one, some, or all of the previous aspects, the method includes rendering an annotated receipt preview for user validation of item names, prices, or receipt source.

In another aspect combinable with one, some, or all of the previous aspects, the method includes storing transaction session logs including raw receipt data, parsed data, and discrepancy outcomes in a structured event log tied to a user profile.

In another aspect combinable with one, some, or all of the previous aspects, the method includes converting the receipt image into digital data using receipt layout templates and NLP-based entity recognition tuned to regional store formats.

In another aspect combinable with one, some, or all of the previous aspects, the method includes generating a push notification, app badge, or SMS alert summarizing price mismatches and prompting user review before sending a claim.

In another aspect combinable with one, some, or all of the previous aspects, the purchase information includes price of the consumer item.

In another aspect combinable with one, some, or all of the previous aspects, the communication includes an email, a phone call, a web form, or a human interaction.

In a fourth example implementation of the present application, a method for verifying a purchase receipt includes identifying purchase information from the purchase receipt, receiving expected purchase information from a database, in which the expected purchase information associated with a consumer item represented by the purchase information, determining a purchase price difference between the purchase information and the expected purchase information, generating, based on the purchase price difference, a communication with a corresponding retailer, and initiating transmission of the communication to the corresponding retailer.

In an aspect combinable with the fourth example implementation, the method includes receiving an image of the purchase receipt.

In another aspect combinable with one, some, or all of the previous aspects, the method includes displaying the image of the receipt on a user interface and displaying the purchase information on the user interface.

In another aspect combinable with one, some, or all of the previous aspects, the method includes storing the purchase information, the expected purchase information, and the difference in a database.

In another aspect combinable with one, some, or all of the previous aspects, the method includes converting the image of the receipt into a digital representation of the image of the receipt using optical character recognition.

In another aspect combinable with one, some, or all of the previous aspects, the method includes generating a notification in response to the purchase price difference between the purchase information and the expected purchase information.

In another aspect combinable with one, some, or all of the previous aspects, the purchase information includes a price of the consumer item.

In another aspect combinable with one, some, or all of the previous aspects, the communication includes an email, a phone call, a web form, or a human interaction.

Other example implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments to realize one or more of the following advantages. A recommendation of a shopping trip based on user preferences, shopping trip criteria, and a complete list of shopping items provides personalized shopping trip experiences, which reflect preferences of individual shoppers. By considering preferences, details of multiple shopping locations, and real-time pricing data, a processor can implement instructions for determining multiple shopping trip options with accurate product characterizations. Personalized shopping experiences provide an increased customer satisfaction and loyalty.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example shopping trip recommendation system.

FIG. 2 is an example process for generating shopping trip recommendations.

FIG. 3 shows an example illustration of a user interface.

FIG. 4 shows an example illustration of a user interface.

FIG. 5 is a block diagram of an example system architecture.

FIG. 6 is a block diagram of an example receipt verification system.

FIG. 7 is an example process for verifying a receipt.

FIG. 8 shows an example illustration of a user interface.

### DETAILED DESCRIPTION

The present disclosure is directed towards systems, methods, and computer programs, for determining a sequence of shopping locations, in which each shopping location offers at least one shopping item from a list of multiple shopping items. Aspects of the present specification employ a user interface and machine learning models to improve a recommendation system that provides recommended lists of shopping items and sequences of shopping locations to purchase the recommended shopping items based on historical shopping data, user preferences, and real-time (e.g., continuously updating) pricing and inventory data.

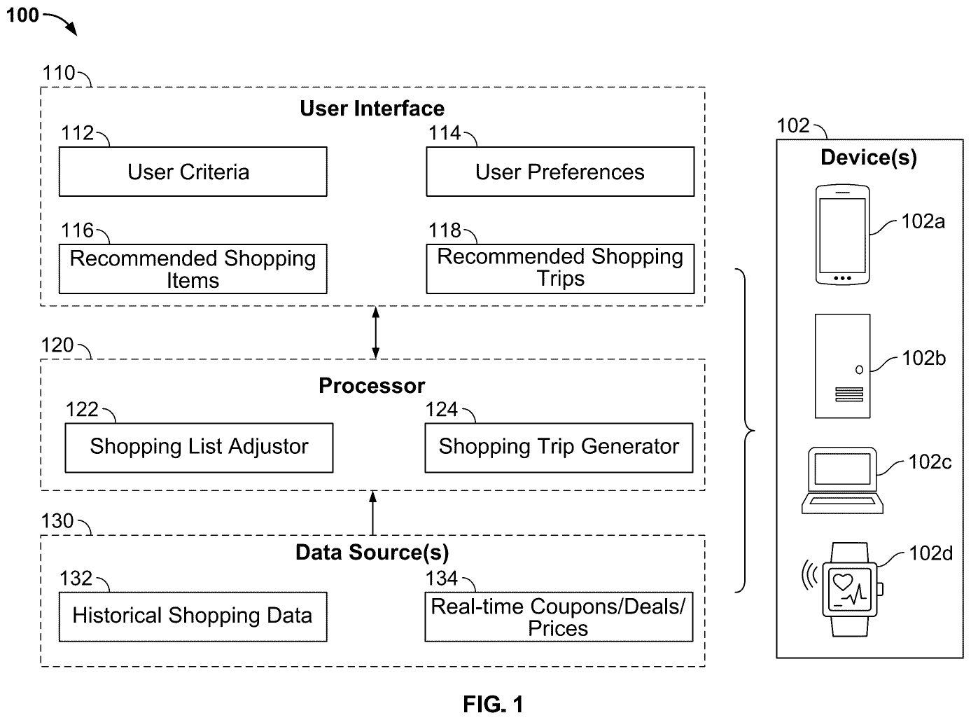

FIG. 1 is a block diagram of an example shopping trip recommendation system 100. The system 100 includes a user interface 110, a processor 120, and data sources 130. In example implementations, a device 102, e.g., a mobile device 102a, a server 102b, a laptop computer 102c, or a wearable device 102d, includes the user interface 110, the processor 120, and the data sources 130. In some other implementations, the device 102 includes the user interface 110 and the device 102 is communicatively coupled with the processor 120 and/or data sources 130 that are implemented on computing resources separate from the device 102.

The user interface 110 enables interaction with a user, e.g., a shopper. The user interface 110 includes interface elements, e.g., input fields, text boxes, sliders, etc., to receive user preferences 114 and user criteria 112. In some cases, processes implemented by the processor 120 process the user preferences 114 and/or the user criteria 112 to determine characteristics of a list of shopping items and/or a sequence of shopping locations. For example, a shopping list adjustor 122 processes the user preferences 114, historical shopping data 132, and real-time coupons, deals, and prices to determine a recommended list of shopping items. Relatedly, a shopping trip generator 124 process the user preferences 114, user criteria 112, historical shopping data 132, and other data sources like distances to shopping locations, traffic, etc., to determine sequences of shopping locations.

In example implementations, the system collects one of more of the user preferences 114 through the user interface 110. In example implementations, the system collects one or more of the user preferences 114 through third-party applications. In some cases, the system 100 can collect, infer, or calculate one or more expected user preferences of the user preferences 114 based on indirect data. For example, the system 100 can consider historical shopping patterns, preferences of similar shoppers, etc. Examples of the user preferences 114 include budget price, dietary restrictions, brand preferences, shopping frequency, preferred retailers, specific product requirements, inventory sensitivity, payment methods, loyalty preferences and/or availability, safety sensitivities, product and/or retailer ratings, pick-up and/or delivery options, retailer checkout model, store cleanliness, store safety factors, store hours, and store experience ratings.

In example implementations, the shopping list adjustor 122 determines an initial list of shopping items based on one or more parameters, e.g., historical shopping patterns of a particular user. In example implementations, the shopping list adjustor 122 adjusts the initial list of shopping items based on one or more user preferences 114, e.g., one of the example user preferences listed above. For example, the initial list of shopping items can include a product offered at a first price manufactured by a first brand that is sold at a first retailer. After processing the user preferences 114, user preferences related to budget price, brand preference, and retailer checkout model may result in a modified list of shopping items that includes the product offered at a second price manufactured by a second brand that is sold at a second retailer, in which the first and second options differ.

In example implementations, the system 100 stores the user preferences 114 in a secure database. In example implementations, the secure database is remote from the device 102. In some other implementations, the secure database is local to the device 102.

In example implementations, a user updates the user preferences 114 to accurately reflect current preferences. In example implementations, the user updates the user preferences 114 through the user interface 110. In some other implementations, the user updates the user preferences 114 indirectly through communication with a server or processor of the system 100. In some other implementations, the system 100 infers changes to the user preferences 114 and updates them accordingly.

A list of recommended shopping items 116 are displayed on the user interface 110. In example implementations, a user can adjust the list of recommended shopping items 116. For example, a user can remove a shopping item, adjust a quantity of a shopping item, add additional shopping items, or replace a shopping item with a different shopping item.

In example implementations, the shopping trip generator 124 generates multiple sequences of shopping locations, e.g., recommended shopping trips 118, based on the user criteria 112 and attributes of each of the recommended shopping items 116. Each trip of the recommended shopping trips 118 includes one or more shopping locations, e.g., stores. Each store offers at least one of the recommended shopping items 116. In some cases, the shopping trip generator 124 generates multiple trip options, in which each trip option is optimized for different parameters. For example, a first trip is optimized for total distance traveled, a second trip is optimized for fewest number of stores, and a third trip is optimized for lowest total cost. The user can view each of the recommended shopping trips 118 on the user interface 110. In example implementations, a user can modify each of the recommended shopping trips 118. The user can select a particular trip of the recommended shopping trips 118. In some cases, the selected trip is a manually modified version of one of the recommended shopping trips 118 generated by the shopping trip generator 124.

The shopping list adjustor 122 and the shopping trip generator 124 accesses one or more data sources 130 to help determine the recommended shopping items 116 and the recommended shopping trips 118 respectively. The data sources 130 include historical shopping data 132 of a particular user or of similar users. In some cases, the historical shopping data 132 is stored in a database and accessed by the processes executed on the processor 120. The data sources 130 include real-time coupons, deals, prices, etc., that are specific to shopping locations in particular regions that a relevant for a particular user. For example, for a fixed set of products, the shopping list adjustor 122 can generate a list of recommended shopping items on a first day and a different list of recommended shopping items on a second day because the real-time data may include different coupons on the first day from the second day. The change in coupon availability between the two days results in a different list of recommended shopping items 116 for the same set of products.

In example implementations the shopping list adjustor 122 and the shopping trip generator 124 implement instructions according to one or more machine learning models. In example implementations, the system trains the machine learning models on historical shopping data to identify patterns in shopping behavior at an individual level, among cohorts of similar shoppers, and among all shoppers. In example implementations, the system trains the machine learning models to generate personalized recommendations that align with the user preferences 114, including product suggestions, product quantities, budget, and alternative options. The trained machine learning models generate output recommendations based on values, in addition to product and/or category parameters.

In example implementations, the system trains the machine learning models with training data that includes multiple features. The features include price, proximity, retailer loyalty, inventory confidence, substitution preferences, payment methods and/or loyalty considerations, level of promotion (e.g., on sale vs. not on sale), available discounts and/or promotions, assortment options (e.g., SIN products), safety rating, services and amenities (e.g., bathrooms, lottery products, cash back offering, bill payment offering), customer ratings, store checkout model, store labor model, customer schedule, customer transportation options, diet preferences and needs, store cleanliness, customer services quality, friendliness of staff, store hours, and crowdedness. In example implementations, additional criteria and attributes are inferred, collected, estimated, and/or learned over time. In example implementations, the machine learning models process one or more of the above features to determine the list of recommended shopping items 116 and/or the recommended shopping trips 118.

In example implementations, the system records feedback from users and/or receives feedback from usage data to further improve the machine learning models. For example, a particular user may continuously replace a particular shopping item with a different shopping item. The personalized machine learning model can be re-trained to include training data that represents this preference. As another example, the system can record user activity across cohorts of users to provide feedback and resulting modifications to the training data that determines the weights of the machine learning models.

In example implementations, the user interface 110 includes a visualization of each trip of the recommended shopping trips 118 by displaying a route on a map. Each shopping location is marked on a map along with options for routes between the shopping locations.

In example implementations, the system can include notifications in response to an updated attribute of a shopping item of the list of recommended shopping items 116 or an update to one of the shopping locations. For example, the user interface 110 can include notifications. As another example, the processor 120 can initiate notifications through alternative communication channels including email, text message, phone, chat, etc.

In example implementations, one or more components of the system 100, e.g., the user interface 110 or the processor 120, are implemented as part of a smart home device. Smart home devices include voice assistants and smart refrigerators which can automatically update the user preferences 114 and the list of recommended shopping items 116 based on real-time usage and inventory observed in a user's home and/or business. Smart home devices provide seamless and automated shopping experiences, enhancing convenience for users.

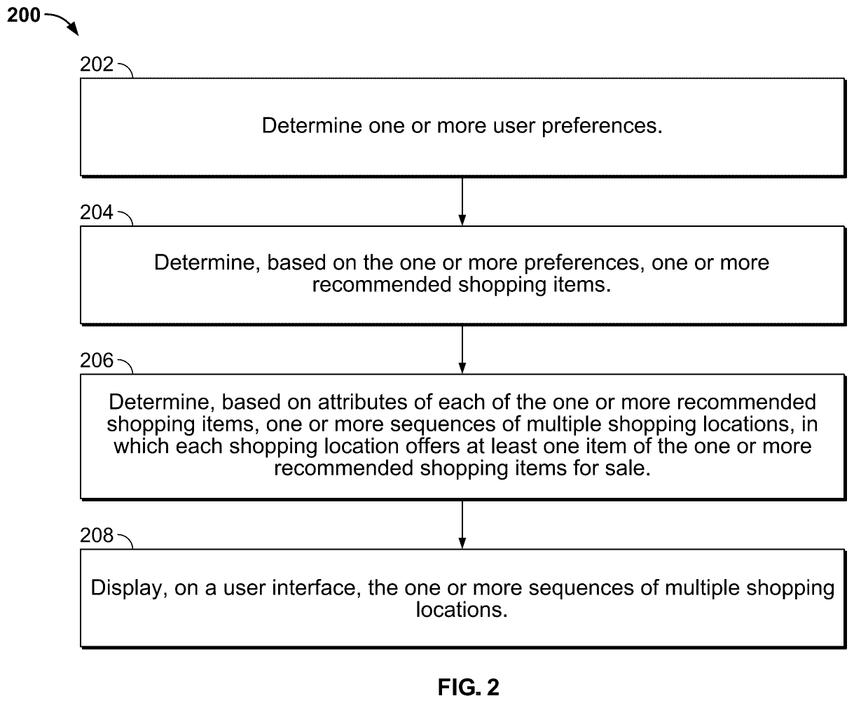

FIG. 2 is an example process 200 for generating shopping trip recommendations. Process 200 is implemented or executed at system 100, referred to as the system below. Hence, descriptions of process 200 will reference the above-mentioned computing resources of system 100. In some examples, the steps or actions of process 200 are enabled by programmed software instructions, firmware instructions, or both. Each type of instruction may be stored in a non-transitory machine-readable storage device and is executable by one or more of the processors or other resources described in this specification.

Referring again to process 200, the system determines (202) one or more user preferences. In example implementations, the user interacts with a user interface to enter the user preferences. In some other implementations, the user interacts with a third party which records and transmits the user preferences to one or more processors or databases of the system. User preferences can include price, proximity, inventory confidence, etc.

The system determines (204), based on the one or more preferences, one or more recommended shopping items. In example implementations, the system implements one or more machine learning models trained on historical shopping data and usage data to generate the recommended shopping items.

The system determines (206), based on attributes of each of the one or more recommended shopping items, one or more sequences of multiple shopping locations, in which each shopping location offers at least one item of the one or more recommended shopping items for sale. In example implementations, the system implements one or more machine learning models trained on historical shopping data and historical shopping trip data to generate recommended shopping trips. In addition, the system considers real-time (e.g., continuously updating) data from web scraping, real-time databases, retailer integrations etc., to provide accurate recommendations. In some implementations, the system communicates with a model context protocol (MCP) server to interact with one or more AI agents to retrieve product and store information. The system processes user criteria and user preferences that include price, number of stops, trip distance, etc.

The system displays (208), on a user interface, the one or more sequences of multiple shopping locations. In example implementations, a user can view details about the shopping items and the shopping locations and adjust the items and locations according to current needs.

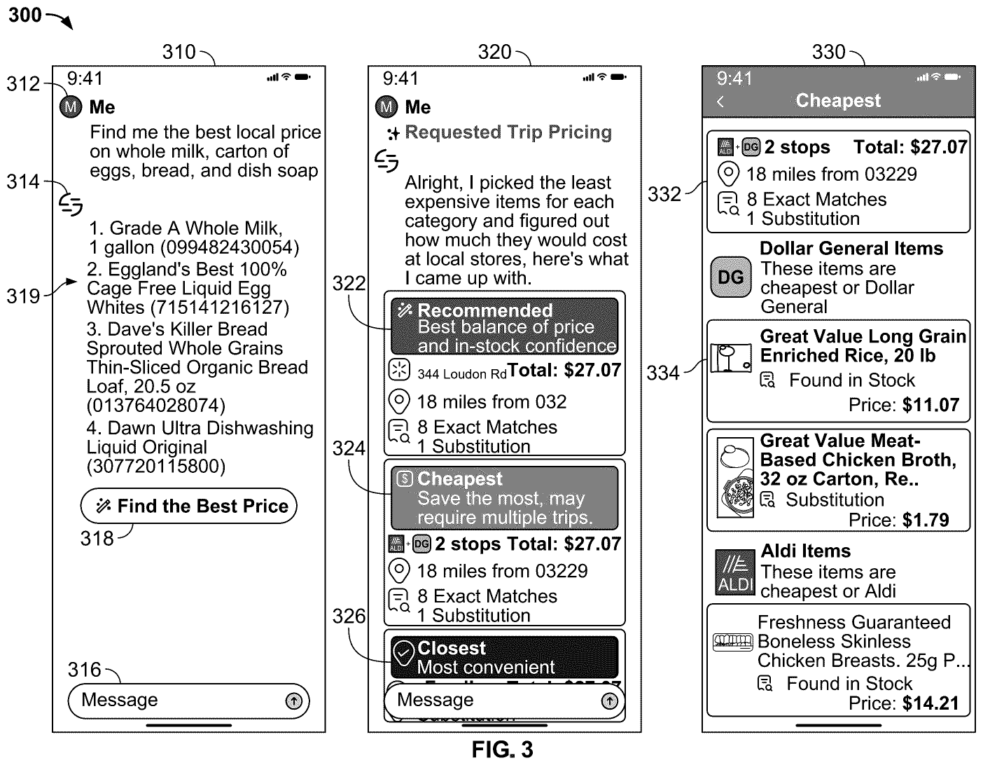

FIG. 3 shows an example illustration 300 of a user interface. The illustration 300 includes three example views of the user interface, in which a first example view 310 illustrates an interaction between a user 312 and an agent 314, a second example view 320 illustrates recommended sequences of shopping locations 322-326, and a third example view 330 illustrates details of a selected sequence of shopping locations.

The first example view 310 includes a conversational interface that includes a text box 316, a message history display 319, and a recommended action button 318. In the first example view 310, the recommended action button 318 corresponds to an action of finding a best price for a list of shopping items provided by the agent 314. In example implementations, the agent 314 is implemented as a Large Language Model (LLM) or other conversational artificial intelligence systems.

In some implementations, a system interacts with the LLM using one or more prompt engineering approaches including rewriter services, multi-query retrievers, a mix-of-granularity chunk optimization service, and pairwise evaluation.

The first example view 310 demonstrates an example conversation between the user 312 and the agent 314. The user 312 states, “Find me the best local price on whole milk, carton of eggs, bread, and dish soap.” The agent 314 responds with four products with respective identifiers that match the requested products from the user 312. The user 312 has the option to find a best price by interacting with the recommended action button 318 to instruct the system to search local retailers for the best price across the four shopping items.

Upon interacting with the recommended action button 318, the agent 314 initiates one or more computational tasks performed by a local or remote processor to access pricing databases and historical shopping data to recommend multiple shopping trip options for the user 312 to purchase the requested shopping items. The second example view 320 includes a response from the agent 314 and three options for sequences of shopping locations for the user 312 to review.

The second example view 320 shows three sequences of shopping locations, in which each shopping location offers at least one of the requested shopping items for sale, e.g., milk, eggs, bread, or soap. The system characterizes a first recommendation 322 as a “recommended” shopping trip, which balances a low price and in-stock confidence across all of the products. The system characterizes a second recommendation 324 as a “cheapest” shopping trip, which reflects a sequence of shopping locations that results in a lowest overall price and may include more shopping locations than other recommendations. The system characterizes a third recommendation 326 as a “closest” shopping trip, which reflects a most convenient sequence of shopping locations. For each recommendation 322-326, the second example view 320 includes a user interface that displays details of the shopping locations, e.g., which retailers will the user 312 visit to purchase the requested items, a total price, and details of the products that will be purchased, e.g., if there are any substitutions in relation to the original list of shopping items.

The third example view 330 shows a detailed view of one of the recommendations 322-326. In particular, the view 330 shows a detailed view of the second recommendation with reflects the “cheapest” shopping trip. In example implementations, each of the recommendations 322-326 are represented by a clickable user interface element, in which a detailed view of the recommendation is viewed upon the element being clicked.

The third example view 330 shows aggregate information about the selected shopping trip 332, and information about each shopping location and information about each product offered for sale 334 at the respective shopping location, e.g., price, in-stock status, description, etc.

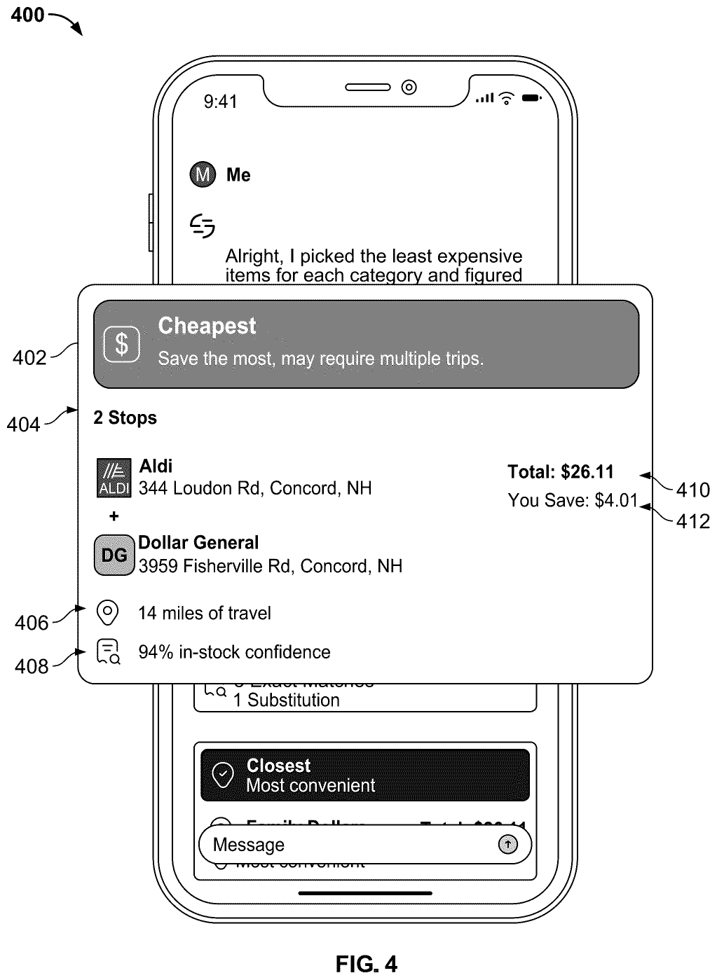

FIG. 4 shows an example illustration 400 of a user interface. The illustration 400 includes an example detailed view 402 of a selected shopping trip. The detailed view 402 includes an indicator 404 of a number of stops, e.g., individual retailers or stores, included in the selected shopping trip, a total price 410 of the shopping items, a savings amount 412, a total distance travelled 406, and a confidence score 408 determined by the system that reflects a likelihood of all of the shopping items to be in-stock at the recommended shopping locations.

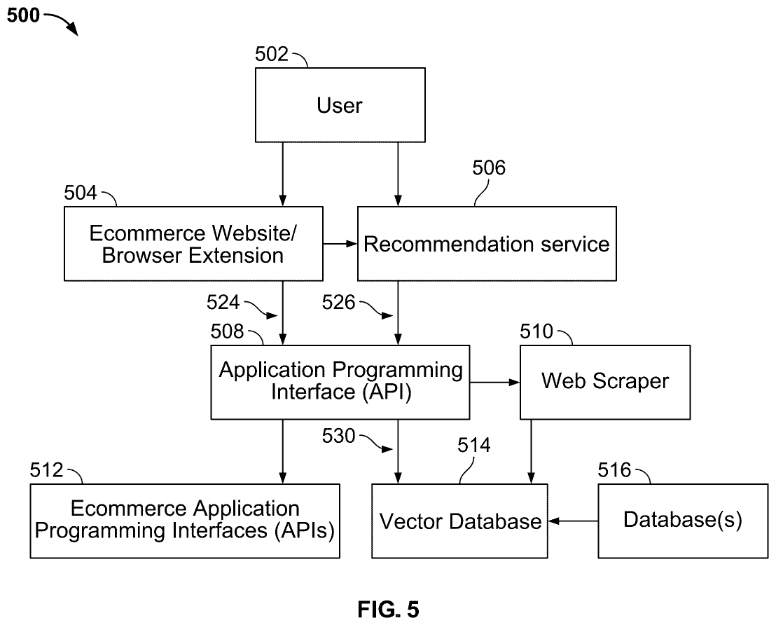

FIG. 5 is a block diagram of an example system architecture 500 that enables a user 502 to interact with a recommendation service 506 through a retailer interface 504 or directly with the recommendation service 506. The example system architecture 500 illustrates an ability for the user 502 to add shopping items to one or more system databases and receive recommended shopping items and shopping trip recommendations based on real-time pricing and product information, as described in relation to the system 100 of FIG. 1.

The example system architecture 500 illustrates an interaction between the user 502 and a retailer interface 504 through an e-commerce website or a web browser extension. In example implementations, a browser extension enables the user 502 to add shopping items to a shopping cart based on shopping items viewed with a web browser on a retailer interface, e.g., a retailer website. In some other implementations, a retailer website (e.g., related user interfaces and/or servers of the retailer) is communicatively coupled with the recommendation service 506, e.g., via an application programming interface (API).

The recommendation service 506 can receive shopping item data, user preferences, user criteria, and other information directly from the user 502 through an API endpoint or a user interface. In addition, the recommendation service 506 can receive the same information through an intermediate service like a web browser extension or a third-party API integration with specific retailers.

An API interface 508 can facilitate a transfer of information from the retailer interface 504 and the recommendation service 506 through data paths 524 and 526 respectively to multiple resources. The API interface 508 can transfer information received from data paths 524 and 526 to other e-commerce APIs 512, vector databases 514, or web scrapers 510. In example implementations, the API interface 508 represents a set of microservices that web resources can access to perform a variety of functions including planning shopping trips, adjust receipt discrepancies, and authenticate with various retailers or other third parties to directly access third-party resources (e.g., to place an order directly with a particular retailer).

In example implementations, the API interface 508 transfers information received through data paths 524 and 526 to a web scraper 510. The web scraper 510 accesses pricing and inventory data from retailers in particular regions (e.g., via webpages, retailer databases, or from AI agents through an MCP server). The web scraper 510 can access continuously updating pricing and inventory data to provide up-to-date information for the system to process. In example implementations, the web scraper 510 accesses updated retailer information independent of API requests and saves the updated information in one or more databases accessed by the API interface 508.

In some implementations, the system architecture 500 includes a caching mechanism of one or more data fields, e.g., prices and inventory. For example, as the web scraper 510 accesses and stores updated pricing and inventory values, the values can be stored locally to reduce query times. Relatedly, the system architecture 500 can include one or more databases of the databases 516 that store aggregated product data. Using semantic analysis of vector database queries, discussed in more detail below, similar products can be groups together to provide faster queries. Similarly, the databases 516 and database managing systems can implement data sharing, data partitioning at a data store level to split data, balance load, and improve performance, e.g., query response time. By normalizing and standardizing data of diverse data sets, the product and inventory data of the databases 516 are storage efficient and maintain consistent records.

Vector databases are commonly used for storing large amounts of unstructured and structured data. The data is represented as numerical vectors that capture the semantic meaning of the information it is representing, e.g., text, audio, video, etc. The vector database 514 stores data acquired by the web scraper 510 (e.g., prices, product descriptions, retailer location description, etc.). Systems can access the data stored in the vector database 514 by sending a query through the API interface 508 and subsequently through the data path 530. In example implementations, a processor is configured to interpret a request received by the API interface 508, format the request in accordance with requirements of the vector database 514, issue the request, receive the results, and format the results to be processed by a downstream application.

In addition to the data received by the web scraper 510, the vector database 514 stores data from one or more external databases 516. In example implementations, a database of the external databases 516 include pricing information, product information, and retailer-specific information. In example implementations, an extract transform load (ETL) process is implemented to transform the data stored in the databases 516 to be suitable for storage in the vector database 514.

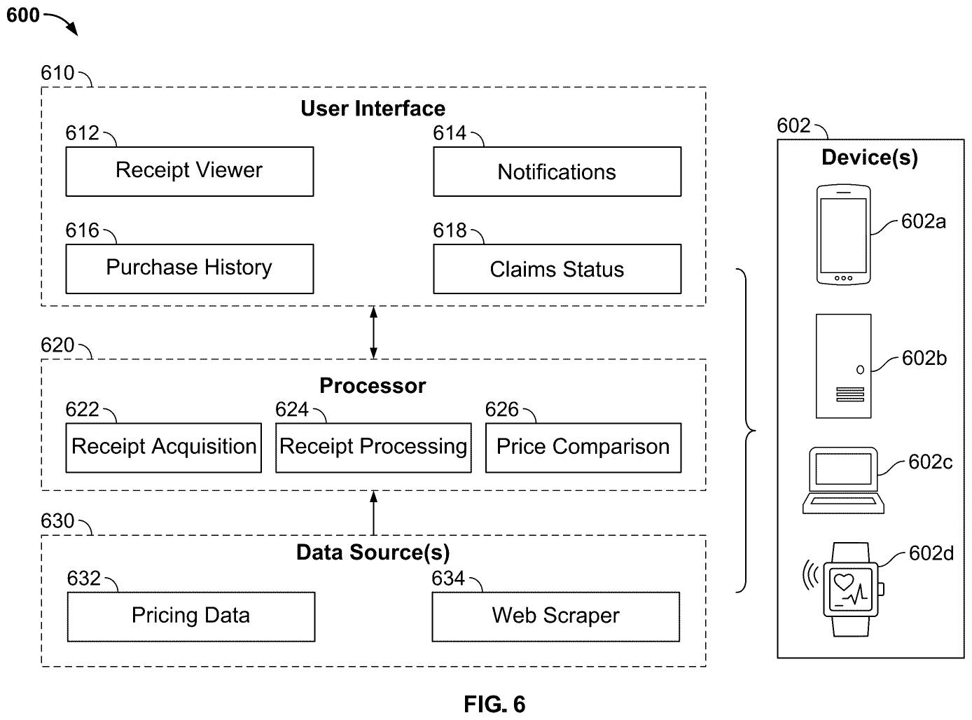

FIG. 6 is a block diagram of an example receipt checking system 600. The system 600 includes a user interface 610, a processor 620, and data sources 630. In example implementations, a device 602, e.g., a mobile device 602a, a server 602b, a laptop computer 602c, or a wearable device 602d, includes the user interface 610, the processor 620, and the data sources 630. In some other implementations, the device 602 includes the user interface 610 and the device 602 is communicatively coupled with the processor 620 and/or data sources 630 that are implemented on computing resources separate from the device 602.

The processor 620 performs operations associated with multiple processes, including receipt acquisition 622, receipt processing 624, and price comparison 626. In some implementations, the receipt acquisition 622 includes receiving digital receipts from third party providers, scanning paper receipts, processing receipt images, and performing optical character recognition (OCR) on images to determine number values, e.g., prices, associated with a purchase represented by the receipt. The user interface 610 includes a receipt viewer 612, which enables a user to view an acquired receipt from the receipt acquisition 622 process.

The processor 620 implements the receipt processing 624 operations that include image processing, natural language processing, and processing of unstructured data by a trained neural network (e.g., a pre-trained large language model). In some implementations, a system interacts with a pre-trained large language model using one or more prompt engineering approaches including rewriter services, multi-query retrievers, a mix-of-granularity chunk optimization service, and pairwise evaluation.

The processor 620 implements the price comparison 626 operations that include processing pricing information from the receipt processing 624 operations, pricing data 632, and in some implementations, data from a web scraper 634. In some implementations, the web scraper 634 accesses data hosted on the internet on behalf of a third party, in which the data includes pricing data, inventory data, coupon/deal/sale data, and other data related to consumer products offered for sale. In some implementations, the price comparison 626 executes comparisons as receipts are retrieved and processed by the receipt acquisition 622 and the receipt processing 624 systems. In some implementations, the web scraper 634 is initiated automatically, on a schedule, or in response to a notification and/or manual action.

In some implementations, the user interface 610 displays notifications 614 in response to outputs from the price comparison 626 system. For example, the notifications 614 can indicate a detected price discrepancy between a processed receipt and pricing data received by the web scraper 634 and/or the pricing data 632 stored in a local or remote database.

In some implementations, the user interface 610 includes a purchase history 616 that includes past purchases of a particular user or account that accesses the system 600. In some implementations, the purchase history 616 includes purchase details including product information, pricing information, shopping location information, and/or images of associated receipts that describe the transaction.

In some implementations, the system 600 facilitates a submission of claims to a shopping location/retailer on behalf of a user in response to a detected price discrepancy by the price comparison 626 system. The user interface 610 includes claims status indicators 618 that display pertinent information regarding submitted claims. In some implementations, the claim status indicators 618 include information about the detected price discrepancy, product information, shopping location information (e.g., retailer information), relevant dates to the claim, and whether the claim has been reviewed and/or processed by the shopping location and/or retailer.

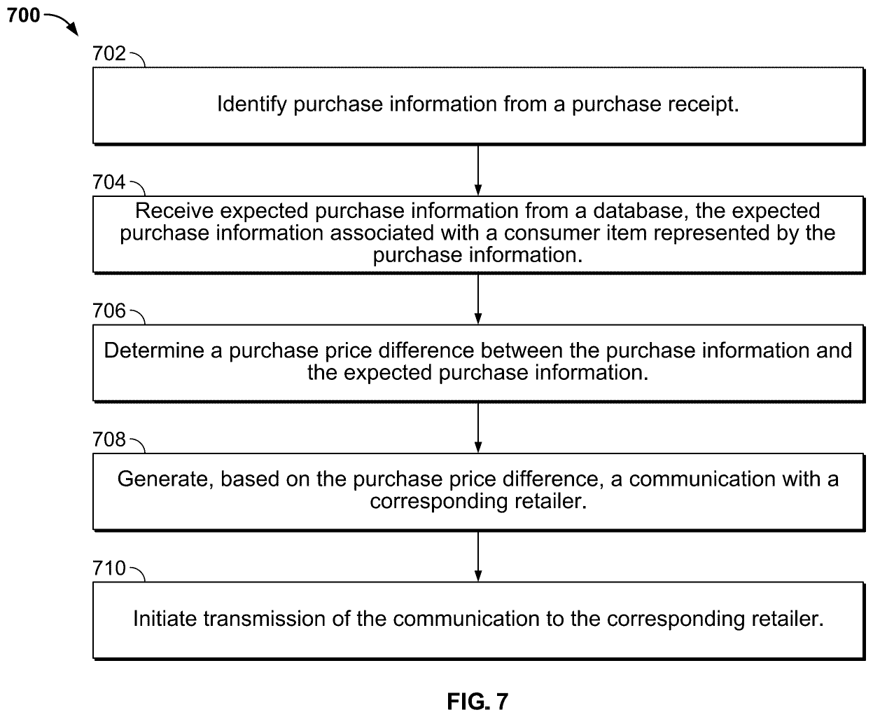

FIG. 7 is an example process 700 for verifying a purchase receipt. Process 700 is implemented or executed at system 600, referred to as the system below. Hence, descriptions of process 700 will reference the above-mentioned computing resources of system 600. In some examples, the steps or actions of process 700 are enabled by programmed software instructions, firmware instructions, or both. Each type of instruction may be stored in a non-transitory machine-readable storage device and is executable by one or more of the processors or other resources described in this specification.

Referring again to process 700, the system identifies (202) purchase information from a purchase receipt. In some implementations, the system identifies (202) purchase information by processing an image of a purchase receipt with optical character recognition (OCR) and performing natural language processing operations and/or rules-based processing of the processed image. In some other implementations, the purchase receipt is a digital-native document, e.g., from a system communicatively coupled to the system via an API endpoint or another digital communication channel that transmits structured data.

The system receives (704) expected purchase information from a database, in which the expected purchase information is associated with a consumer item that is represented by the purchase information. In some implementations, data represented in the database is populated with one or more web scraping processes or acquisition through communication channels that transmit structured pricing and product information. In some implementations, the database is continuously (e.g., at some frequency (daily, hourly, etc.), or upon detected changes of product pricing). In some implementations, the database is local to the processor of the system or remote from the processor of the system and communicatively coupled to at least one processor of the system.

The system determines (706) a purchase price difference between the purchase information and the expected purchase information. As described above, the system determines the purchase information through purchase receipt analysis and the expected purchase information by querying one or more pricing databases (e.g., retailer databases or MCP servers) and/or determining pricing information from web scraping processes. In some implementations, the purchase price difference is determined by subtracting the purchase price as reflected in the purchase information and the expected price as reflected in the expected purchase information. In some implementations, the purchase price difference is due to a mistake during the transaction between a consumer and a retailer. In some other implementations, the purchase price difference is due to an unrealized benefit (e.g., an unused coupon, an unapplied sale price, etc.).

In some implementations, the purchase price difference, the purchase information, and the expected purchase information are stored in a database. In some implementations, the database is local to a particular device (e.g., the device 602). In some other implementations, the database is remote from the particular device (e.g., the device 602) and is communicatively coupled with the resources of the particular device.

The system generates (708), based on the purchase price difference, a communication with a corresponding retailer. The corresponding retailer offers the consumer item for sale and acted as one party of the two party transaction described by the purchase receipt. In some implementations, the communication is a filed claim via a web form, email, phone call, etc., between a representative of the consumer and a representative of the corresponding retailer.

The system initiates (710) transmission of the communication to the corresponding retailer. In some implementations, the initiation includes sending an email, placing a phone call, recording a voice mail, submitting a web form, etc.

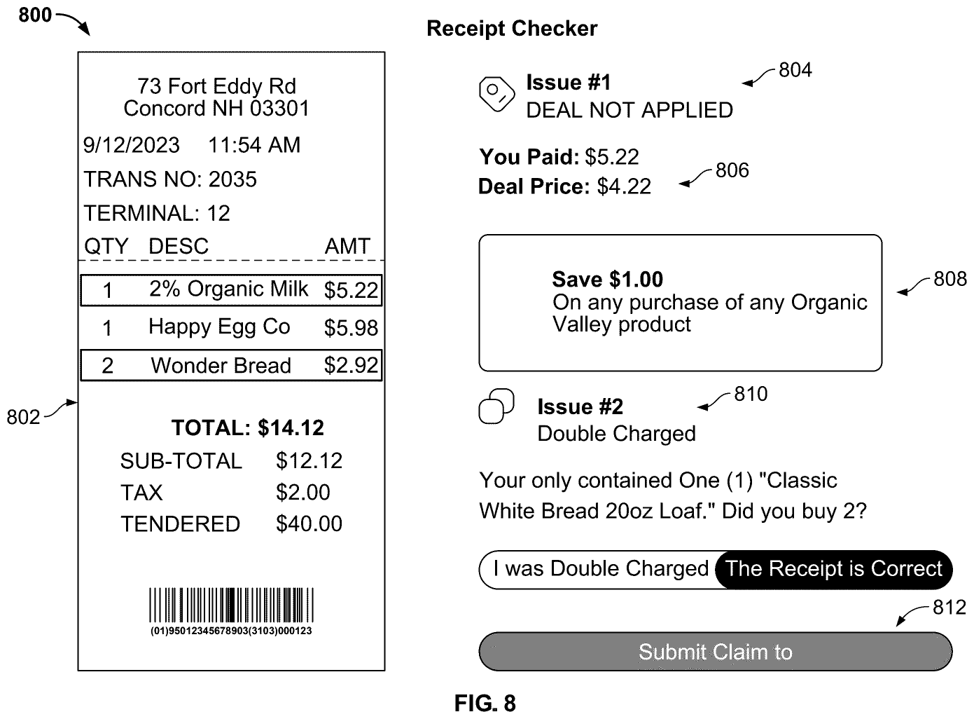

FIG. 8 shows an example illustration 800 of a receipt verification output. The illustration 800 includes an example view of an output from a receipt verification process, as implemented by the system 600 described in relation to FIG. 6.

The example illustration 800 includes a digital representation of a purchase receipt 802. The digital representation of the purchase receipt 802 includes purchase information related to one or more consumer items, as determined by a receipt processor, as described in relation to FIG. 6.

The example illustration 800 includes a first issue 804, in which the first issue 804 includes a summary of the nature of the output of the receipt verification process. The first issue 804 includes a summary of “deal not applied”, which indicates to a consumer that an available sale or discount was not applied at the point of purchase. In some implementations, the system identifies the available sale or discount through a query of a pricing database and/or as a result of a web scraping process, a retailer database, or by interacting with AI agents configured to provide pricing information through an MCP server.

The first issue 804 includes example pricing information 806, which includes a purchase price and an expected purchase price. The example pricing information 806 includes a “you paid” field and a “deal price” field, which summaries the detected purchase price difference, as described above in relation to FIG. 7.

The first issue 804 includes additional detail 808 about the unrealized sale or deal. In some implementations, the additional detail 808 includes an image or description of an available coupon or advertised discount.

The example illustration 800 includes a second issue 810, in which the second issue 810 includes a summary of the nature of the output of the receipt verification process. The second issue 810 includes a summary of “doubled charged”, which indicates to a consumer that a retailer charged the consumer twice for a single consumer item. In some implementations, the system identifies an instance of a double charge through a rules-based algorithm and/or an output of a machine learning model, e.g., a pre-trained large language model.

The example illustration 800 includes a user interface submission button to issue a communication to an associated retailer, e.g., a claim in response to the first issue and/or the second issue. In some implementations, the system initiates the communication on behalf of the consumer.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method for verifying a purchase receipt from a retailer, the method comprising:
extracting one or more line-item purchase information data elements from an image of the purchase receipt, each data element comprising an item name, a quantity, a unit price, and a tax, wherein the image of the purchase receipt is a scanned image of the purchase receipt, or a digital image of the purchase receipt generated by using optical character recognition (OCR);
retrieving, for each data element, expected item pricing data and expected tax data from a retailer-specific database indexed by region and date;
identifying a data element having a difference between a unit price represented in the corresponding data element and an expected unit price represented in the corresponding expected item pricing data, the difference meeting a configurable threshold, wherein the difference is a corresponding purchase price discrepancy;
constructing a discrepancy report having a structured data format, wherein the discrepancy report comprises receipt metadata, itemized differences, and recommended claim language; and
transmitting the discrepancy report to a retailer system over a preferred communication channel determined by a retailer profile associated with the retailer.

2. The computer-implemented method of claim 1, wherein the purchase receipt is received as a digital image, a PDF, or a scanned uploaded image via a mobile application, browser extension, or email ingestion pipeline.

3. The computer-implemented method of claim 1, comprising:
rendering the image of the purchase receipt and parsed purchase data in a side-by-side display format, wherein the parsed purchase data comprises the one or more line-item purchase information data elements, the rendered parsed purchase data having a highlighted purchase price discrepancy and a corresponding confidence score for each data element having a price discrepancy that meets the configurable threshold; and
receiving a user review input and a user confirmation input through an interactive user interface, the user review input comprising corrections and annotations in relation to the rendered parsed purchase data.

4. The computer-implemented method of claim 3, comprising:
storing, in a user-specific and retailer-indexed database, time-stamped data records comprising the image of the purchase receipt, the parsed purchase data, the expected item pricing data for each line-item purchase information data element, and a purchase price discrepancy for each line-item purchase information data element, wherein the storage of the time-stamped data records facilitates an analysis of claim history and claim analytics.

5. The computer-implemented method of claim 1, comprising converting the image of the purchase receipt to a structured digital data format using advanced OCR with contextual text grouping, store layout heuristics, and machine learning (ML)-based normalization of product names.

6. The computer-implemented method of claim 1, comprising generating a personalized alert to a user, wherein the personalized alert comprises a summary of the discrepancy report, the summary comprising an overpayment amount associated with the identified data element, matching policy references associated with the retailer, and a call-to-action for approval or automatic claim filing.

7. The computer-implemented method of claim 1, wherein the line-item purchase information data elements each comprise a line-item price, a tax, applied promotions, loyalty discounts, and store identifiers associated with a corresponding line-item.

8. The computer-implemented method of claim 1, wherein the communication channel comprises one or more of a prefilled retailer web form, a templated customer service email, a phone-based interactive voice response (IVR) script, a chatbot initiation, or a channel for scheduling a live customer support callback.

9. A system comprising one or more computers and one or more storage devices storing instructions that when executed by the one or more computers cause the one or more computers to perform operations comprising:
extracting one or more line-item purchase information data elements from an image of a purchase receipt, each data element comprising an item name, a quantity, a unit price, and a tax, wherein the image of the purchase receipt is a scanned image of the purchase receipt, or a digital image of the purchase receipt generated by using optical character recognition (OCR);
retrieving, for each data element, expected item pricing data and expected tax data from a retailer-specific database indexed by region and date;
identifying a data element having a difference between a unit price represented in the corresponding data element and an expected unit price represented in the corresponding expected item pricing data, the difference meeting a configurable threshold, wherein the difference is a corresponding purchase price discrepancy;
constructing a discrepancy report having a structured data format, wherein the discrepancy report comprises receipt metadata, itemized differences, and recommended claim language; and
transmitting the discrepancy report to a retailer system over a preferred communication channel determined by a retailer profile associated with the retailer.

10. The system of claim 9, wherein the purchase receipt is received as a digital image, a PDF, or a scanned uploaded image via a mobile application, browser extension, or email ingestion pipeline.

11. The system of claim 9, wherein the operations comprise:
rendering the image of the purchase receipt and parsed purchase data in a side-by-side display format, wherein the parsed purchase data comprises the one or more line-item purchase information data elements, the rendered parsed purchase data having a highlighted purchase price discrepancy and a corresponding confidence score for each data element having a price discrepancy that meets the configurable threshold; and
receiving a user review input and a user confirmation input through an interactive user interface, the user review input comprising corrections and annotations in relation to the rendered parsed purchase data.

12. The system of claim 11, wherein the operations comprise:
storing, in a user-specific and retailer-indexed database, time-stamped data records comprising the image of the purchase receipt, the parsed purchase data, the expected item pricing data for each line-item purchase information data element, and a purchase price discrepancy for each line-item purchase information data element, wherein the storage of the time-stamped data records facilitates an analysis of claim history and claim analytics.

13. The system of claim 9, wherein the operations comprise converting the image of the purchase receipt to a structured digital data format using advanced OCR with contextual text grouping, store layout heuristics, and machine learning (ML)-based normalization of product names.

14. The system of claim 9, wherein the operations comprise generating a personalized alert to a user, wherein the personalized alert comprises a summary of the discrepancy report, the summary comprising an overpayment amount associated with the identified data element, matching policy references associated with the retailer, and a call-to-action for approval or automatic claim filing.

15. The system of claim 9, wherein the line-item purchase information data elements each comprise a line-item price, a tax, applied promotions, loyalty discounts, and store identifiers associated with a corresponding line-item.

16. The system of claim 9, wherein the communication channel comprises one or more of a prefilled retailer web form, a templated customer service email, a phone-based interactive voice response (IVR) script, a chatbot initiation, or a channel for scheduling a live customer support callback.

17. An apparatus comprising one or more computer storage media that stores instructions that when executed by one or more computers cause the one or more computers to perform operations comprising:
extracting one or more line-item purchase information data elements from an image of the purchase receipt, each data element comprising an item name, a quantity, a unit price, and a tax, wherein the image of the purchase receipt is a scanned image of the purchase receipt, or a digital image of the purchase receipt generated by using optical character recognition (OCR);
retrieving, for each data element, expected item pricing data and expected tax data from a retailer-specific database indexed by region and date;
identifying a data element having a difference between a unit price represented in the corresponding data element and an expected unit price represented in the corresponding expected item pricing data, the difference meeting a configurable threshold, wherein the difference is a corresponding purchase price discrepancy;
constructing a discrepancy report having a structured data format, wherein the discrepancy report comprises receipt metadata, itemized differences, and recommended claim language; and
transmitting the discrepancy report to a retailer system over a preferred communication channel determined by a retailer profile associated with the retailer.

18. The apparatus of claim 17, wherein the purchase receipt is received as a digital image, a PDF, or a scanned uploaded image via a mobile application, browser extension, or email ingestion pipeline.

19. The apparatus of claim 17, wherein the operations comprise:
rendering the image of the purchase receipt and parsed purchase data in a side-by-side display format, wherein the parsed purchase data comprises the one or more line-item purchase information data elements, the rendered parsed purchase data having a highlighted purchase price discrepancy and a corresponding confidence score for each data element having a price discrepancy that meets the configurable threshold; and
receiving a user review input and a user confirmation input through an interactive user interface, the user review input comprising corrections and annotations in relation to the rendered parsed purchase data.

20. The apparatus of claim 19, wherein the operations comprise:
storing, in a user-specific and retailer-indexed database, time-stamped data records comprising the image of the purchase receipt, the parsed purchase data, the expected item pricing data for each line-item purchase information data element, and a purchase price discrepancy for each line-item purchase information data element, wherein the storage of the time-stamped data records facilitates an analysis of claim history and claim analytics.

21. The apparatus of claim 17, wherein the operations comprise converting the image of the purchase receipt to a structured digital data format using advanced OCR with contextual text grouping, store layout heuristics, and machine learning (ML)-based normalization of product names.

22. The apparatus of claim 17, wherein the operations comprise generating a personalized alert to a user, wherein the personalized alert comprises a summary of the discrepancy report, the summary comprising an overpayment amount associated with the identified data element, matching policy references associated with the retailer, and a call-to-action for approval or automatic claim filing.

23. The apparatus of claim 17, wherein the line-item purchase information data elements each comprise a line-item price, a tax, applied promotions, loyalty discounts, and store identifiers associated with a corresponding line-item.

24. The apparatus of claim 17, wherein the communication channel comprises one or more of a prefilled retailer web form, a templated customer service email, a phone-based interactive voice response (IVR) script, a chatbot initiation, or a channel for scheduling a live customer support callback.
